(19) United States
(12) Patent Application Publication
(10) Pub. No.: US 2013/0175071 A1
(43) Pub. Date: Jul. 11, 2013

(54) PLATE-LIKE CONDUCTOR FOR A BUSBAR AND THE BUSBAR CONSISTING OF THE PLATE-LIKE CONDUCTOR

(71) Applicants: TOYOTA JIDOSHA KABUSHIKI KAISHA, Toyota-Shi (JP); SHINWA INDUSTRY CO., LTD., Toyota-Shi (JP); SUMITOMO LIGHT METAL INDUSTRIES, LTD., Tokyo (JP)

(72) Inventors: Kenjiro SHIBA, Takahama-Shi (JP); Yusuke SAKAMOTO, Okazaki-Shi (JP); Hitoshi IMURA, Chiryu-Shi (JP); Takahisa NIIMI, Toyota-Shi (JP); Masaaki SHIMOJI, Toyota-Shi (JP); Haruhisa KONDOU, Toyota-Shi (JP); Mitsuhiro TAMAKI, Toyoake-Shi (JP)

(73) Assignees: TOYOTA JIDOSHA KABUSHIKI KAISHA, Toyota-Shi (JP); SUMITOMO LIGHT METAL INDUSTRIES, LTD., Tokyo (JP); SHINWA INDUSTRY CO., LTD., Toyota-Shi (JP)

(21) Appl. No.: 13/711,762

(22) Filed: Dec. 12, 2012

(30) Foreign Application Priority Data
Jan. 11, 2012 (JP) 2012-002792

(51) Int. Cl. H01B 1/02; H01B 13/00

(52) U.S. Cl. CPC H01B 1/023; H01B 13/00
USPC 174/126.2; 228/193

(57) ABSTRACT

A plate-like conductor for a busbar, which is a clad member consisting of two copper layers derived from respective two copper plates clad on respective opposite major surfaces of an aluminum plate, an aluminum layer derived from the aluminum plate and formed integrally with the copper layers, and two alloy layers consisting of aluminum and copper and formed between the aluminum layer and the two copper layers.

The present application is based on Japanese Patent Application No. 2012-002792 filed on Jan. 11, 2012 the contents of which are incorporated herein by reference.

### BACKGROUND OF THE INVENTION

1. Field of the Invention

The present invention relates generally to a plate-like conductor for a busbar and a busbar consisting of the plate-like conductor, and more particularly to a conductor for a busbar, which is suitably used for a power control unit (PCU) for bullet train (Shinkansen) cars, linear motor cars and hybrid motor cars, for example.

2. Discussion of Related Art

Plates made of a copper material having a higher degree of electric conductivity such as oxygen-free copper, tough pitch copper and phosphorus-deoxidized copper are conventionally used for an electric conductor for a busbar employed for a PCU for bullet train (Shinkansen) cars, linear motor cars and hybrid motor cars. Plates made of a copper alloy material having a higher degree of electric conductivity and subjected to Ni electroplating are used when the electric conductor is required to have a higher degree of strength. However, copper and copper alloy materials have relatively heavy weights and are not preferred for components of vehicles, which are required to have reduced weights to improve fuel economy of the vehicles. Therefore, an alternative material for the light-weight electric conductor is desired. Further, the Ni electroplating has a potential problem of a high cost.

In view of the problem indicated above, aluminum has been attracting attention as an alternative material for an electric conductor for a busbar, owing to its low cost and contribution to reduction of weight. Among aluminum materials having an industrial purity, JIS A1060 aluminum material is considered to be particularly effective to obtain 61% of IACS conductivity and JIS A6101 aluminum alloy material is used when a higher degree of strength is required. However, when the above described aluminum and aluminum alloy materials are used for the conductor for the busbar, the following problem is encountered. Aluminum and aluminum alloys (hereinafter referred to collectively as “aluminum”) necessarily have lower degrees of electric conductivity than copper and copper alloys. Therefore, it is necessary to coat surfaces of an aluminum material with expensive Ni by plating or thermal spraying. When a plate made of an aluminum material is coated with Ni, the aluminum material is exposed at its end faces. Therefore, when the aluminum material is used under a high-temperature and high-moisture condition, a difference in potential between aluminum and Ni tends to cause corrosion of the material, giving rise to a problem of insufficient resistance to corrosion.

Therefore, aluminum conductors whose surfaces are coated with a Zn film, a Cu plating layer, or a Sn or Ag layer are proposed in JP-A-7-102356, JP-A-8-47793 and JP-A-11-302855 as alternatives for the aluminum conductor coated with Ni as described above. However, when the aluminum conductors coated with Zn, Cu, Sn or Ag are made in the form of a plate, the conductors suffer from formation of a cell due to a difference in potential between their base material of aluminum and the coating metal of Zn, Cu, Sn or Ag, giving rise to a potential problem of rapid corrosion.

### SUMMARY OF THE INVENTION

The present invention was made in view of the background art described above. It is a first object of the present invention to provide a plate-like conductor for a busbar which has a higher degree of resistance to corrosion and which is economical to produce. It is a second object of the present invention to provide a busbar consisting of the plate-like conductor. It is a third object of the present invention to provide a method of advantageously producing the plate-like conductor for a busbar.

It is generally known that in a plate-like conductor for a busbar, a surface current flows through opposite major surfaces of the conductor having a relatively large area. It was found that a high-frequency current flows about 10-400 μm below the major surfaces, in PCU for bullet train (Shinkansen) cars, linear motor cars and hybrid motor cars, in particular. Therefore, the inventors of the present invention considered to produce a plate-like conductor having a basic structure consisting of a base made of an aluminum or aluminum alloy material to reduce the production cost and weight of the conductor, and layers of a copper material having a higher degree of electric conductivity such as oxygen-free copper, tough pitch copper and phosphorus-deoxidized copper, which layers are disposed on the opposite major surfaces of the conductor. However, it was found that the above-described plate-like conductor could not solve the conventionally encountered problem of insufficient corrosion resistance.

In view of the above-indicated finding, the inventors of the present invention made a further study on various methods of disposing a copper material on the opposite major surfaces of an aluminum plate. The study revealed that when a desired conductor is obtained by superposing on each other an aluminum plate and copper plates whose cladding surfaces have been cleaned by a degreasing or other cleaning treatment, and by subjecting a stack of the plates to a clad-rolling operation while being heated to a temperature of 200-450° C., rather than by bonding or plating the copper plates to or on the opposite major surfaces of the aluminum plate as in the conventional method, oxide films existing in the areas of boundary between the aluminum and copper materials are destructed owing to the clad-rolling operation, and the aluminum and copper materials are directly combined with each other under a high pressure, so as to form alloy layers having excellent properties in the areas of boundary. Thus, the present invention was made.

The first object indicated above can be achieved according to a first aspect of the present invention, which provides a plate-like conductor for a busbar, which is a clad member consisting of two copper layers derived from respective two copper plates clad on respective opposite major surfaces of an aluminum plate, an aluminum layer derived from the aluminum plate and formed integrally with the copper layers, and two alloy layers consisting of aluminum and copper and formed between the aluminum layer and the respective two copper layers.

According to a preferable form of the first aspect of the present invention, each of the two copper layers has a thickness of 0.01-0.8 mm, and the aluminum layer has a thickness of 0.2-2 mm, while each of the two alloy layers has a thickness of 0.01-0.4 mm, the clad member having a total thickness of 0.25-4 mm.

According to a preferable form of the first aspect of the present invention, the clad member is formed by superposing the two copper plates on the opposite major surfaces of the aluminum plate, to form a stack of the two copper plates and the aluminum plate, and clad-rolling the stack while being heated.

According to a preferable form of the first aspect of the present invention, the copper plates are made of a copper material or a copper alloy material.

According to a preferable form of the first aspect of the present invention, the copper material is any one of oxygen-free copper, tough pitch copper and phosphorus-deoxidized copper.

According to a preferable form of the first aspect of the present invention, the aluminum plate is made of an aluminum material or an aluminum alloy material.

According to a preferable form of the first aspect of the present invention, the aluminum material is 1000 series aluminum of JIS.

According to a preferable form of the first aspect of the present invention, the aluminum alloy material is a 6000 series aluminum alloy of JIS.

The second object indicated above can be achieved according to a second aspect of the present invention, which provides a busbar consisting of the above-described plate-like conductor.

The third object indicated above can be achieved according to a third aspect of the present invention, which provides a method of producing a plate-like conductor for a busbar, comprising the steps of: superposing two copper plates on opposite major surfaces of an aluminum plate to form a stack of the two copper plates and the aluminum plate; and clad-rolling the stack while being heated to form the plate-like conductor for a busbar, which is a clad member consisting of two copper layers derived from respective two copper plates clad on respective opposite major surfaces of an aluminum plate, an aluminum layer derived from the aluminum plate and formed integrally with the copper layers, and two alloy layers consisting of aluminum and copper and formed between the aluminum layer and the respective two copper layers.

According to a preferable form of the third aspect of the present invention, the stack is heated to 200-450° C.

According to another preferable form of the third aspect of the present invention, cladding surfaces of at least one of the copper plates and the aluminum plate are subjected to a surface roughening treatment.

It is to be understood that the term “aluminum” in the following description is used as a general term of aluminum and aluminum alloys, namely, aluminum materials having an aluminum content of not lower than 99.0% and aluminum alloy materials containing Cu and Mn as alloy components, and having an aluminum content of lower than 99.0%.

The plate-like conductor for a busbar according to the present invention is configured such that the two copper plates are clad on the opposite major surfaces of the aluminum plate, and the alloy layers consisting mainly of aluminum and copper are formed between the aluminum layer derived from the aluminum plate and the copper layers derived from the copper plates. Therefore, the plate-like conductor according to the present invention can exhibit not only a high degree of electric conductivity, but also a high degree of corrosion resistance owing to effective prevention of electric corrosion which would be caused by a difference in potentials between the aluminum and copper materials.

The copper and aluminum constituting the above-described conductor are both soft metals so that the conductor is generally difficult to be fixed with screws. However, the alloy layers consisting mainly of the aluminum and copper according to the present invention have a higher degree of hardness, making it possible to fix the conductor with screws in various kinds of applications, allowing the conductor to be advantageously used for a busbar.

It is considered that the alloy layers consist mainly of the aluminum and copper diffused and mixed with each other, in the absence of any apparent intermetallic compound. The expression “mainly” is used herein since it is considered that a trace amount of elements contained as impurities in the aluminum and copper is diffused in the alloy layers. Each of the alloy layers is not brittle, and has a higher degree of adhesiveness to the aluminum and copper layers disposed on the respective opposite sides of the corresponding alloy layer. It is to be particularly noted that the presence of the alloy layers prevents corrosion which would be caused by a difference in potentials between the aluminum and copper materials, making it possible to effectively improve durability of the conductor.

### BRIEF DESCRIPTION OF THE DRAWINGS

The above and other objects, features, advantages of the present invention will be better understood by reading the following detailed description of a preferred embodiment of the present invention, when considered in connection with the accompanying drawings, in which:

FIG. 1 is a schematic cross sectional view showing a process of obtaining a plate-like conductor for a busbar according to one embodiment of the present invention; and

FIG. 2 is an enlarged schematic view of part A in FIG. 1.

### DETAILED DESCRIPTION OF THE INVENTION

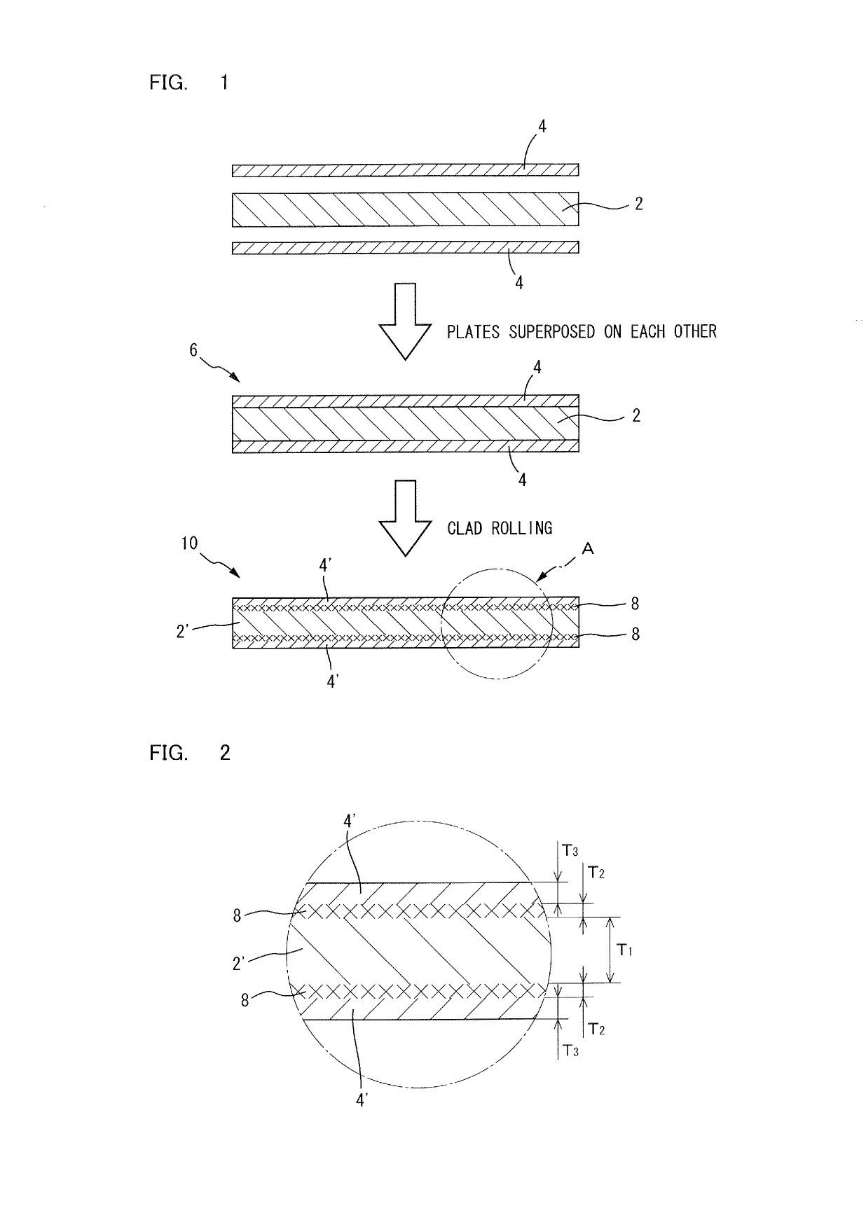

A plate-like conductor for a busbar according to one embodiment of the present invention is obtained as an integral clad body 10 by superposing two copper plates 4, 4 on respective opposite major surfaces of an aluminum plate 2, to form a stack 6, and then clad-rolling the stack 6 under a high pressure as shown in FIG. 1. The aluminum plate 2 is made of an aluminum material or an aluminum alloy material as described above, specifically, 1000 series aluminum materials such as A1060 and A1100 of JIS (Japanese Industrial Standards). When a sufficiently high degree of strength is required, a 6000 series aluminum alloy material such as JIS A6101 is used.

As the copper plates 4, plates made of a copper material such as oxygen-free copper, tough pitch copper and phosphorus-deoxidized copper are advantageously used. However, plates made of a known copper alloy material may be used as needed. It is to be understood that the term “copper” is used herein as a general term of copper and copper alloys.

The aluminum plate 2 and the copper plates 4 are subjected to a known cleaning treatment such as a degreasing treatment so as to make their surfaces, especially, cladding surfaces (mutually contacting surfaces) as clean as possible, thereby preventing impurities from being mixed into alloy layers 8 formed between the aluminum plate 2 and the copper plates 4, in order to advantageously assure desired properties of the alloy layers 8. Further, the cladding surfaces are favorably subjected to a known surface roughening treatment such as a hairline finishing treatment in order to effectively clad the aluminum plate 2 and the copper plates 4 together.

The stack 6 consisting of the aluminum plate 2 and the copper plates 4,4 superposed on the respective opposite major surfaces of the aluminum plate 2 is subjected to a clad-rolling operation under a high pressure while being heated to 200-450° C. by a heating apparatus such as an on-line heater. As a result, apparent boundaries between the aluminum plate 2 and the copper plates 4 disappear, and the two alloy layers 8 are formed between the aluminum plate 2 and the copper plates 4 as shown in FIGS. 1 and 2. In the alloy layers 8, mainly aluminum and copper are diffused and merely mixed with each other without forming any intermetallic compound. Thus, the desired plate-like conductor is formed as the integral clad body 10 in which each of the two alloy layers 8 having a predetermined thickness exists between an aluminum layer 2′ derived from the aluminum plate 2 and the corresponding one of two copper layers 4′ derived from the two copper plates 4.

In the plate-like conductor according to the present invention consisting of the integral clad body 10 obtained as described above, a thickness T₁ of the aluminum layer 2′ constituted by the aluminum plate 2 is preferably 0.2-2 mm, and a thickness T₃ of each of the two copper layers 4′ constituted by the two copper plates 4 is preferably 0.01-0.8 mm, while a thickness T₂ of each of the two alloy layers 8 formed between the aluminum layer 2′ and the copper layers 4′ is preferably 0.01-0.4 mm. A total thickness (T₁+T₂+T₃) of the plate-like conductor in the form of the integral clad body 10 is preferably 0.25-4 mm.

In the integral clad body 10 (plate-like conductor), the thickness T₁ of the aluminum layer 2′ smaller than 0.2 mm gives rise to problems such as difficulty in maintaining required rigidity of a busbar, for example. On the other hand, when the thickness T₁ is larger than 2 mm, the plate-like conductor is unnecessarily thick and heavy, and may not be used as a busbar in a narrow space.

The thickness T₃ of each of the copper layers 4′ smaller than 0.01 mm gives rise to a problem of difficulty of flow of a surface current, which tends to cause reduction of the electric conductivity. On the other hand, the thickness T₃ larger than 0.8 mm is not preferred since it makes it difficult to assure sufficiently high electric conductivity, and causes an undesired increase of the production cost and weight of the conductor.

The thickness T₂ of the alloy layers 8 smaller than 0.01 mm gives rise to a problem of difficulty to improve the corrosion resistance, while the thickness T₂ larger than 0.4 mm does not yield a further increase of the corrosion resistance.

The total thickness (T₁+T₂+T₃) of the integral clad body 10 smaller than 0.25 mm gives rise to a problem of difficulty to maintain required rigidity of a busbar, for example. When the thickness (T₁+T₂+T₃) is larger than 4 mm, the plate-like conductor is unnecessarily thick and heavy, and may not be suitably used as a power supply busbar in a narrow environment.

While one embodiment of the present invention has been described in detail for illustration purpose only, it is to be understood that the present invention is not limited to the details of the illustrated specific embodiment.

For example, it is preferable that the copper plates 4, 4 which are clad on the respective opposite major surfaces of the aluminum plate 2, have the same thickness. However, copper plates having respective different thicknesses may be used. In this case, the alloy layers 8, 8 located on the respective opposite sides of the aluminum layer 2′ may have different thicknesses due to the difference in thickness of the copper layers 4′,4′. In any case, the two copper layers 4′, 4′ need not have the same thickness, and the two alloy layers 8, 8 need not have the same thickness.

Further, it is preferable that the aluminum plate 2 and the copper plates 4, 4 are subjected to a clad-rolling operation, but it is possible to use any other known cladding operation in which the stack 6 consisting of the aluminum plate 2 and the copper plates 4, 4 is pressed or squeezed on its opposite major surfaces, to obtain the clad body 10.

It is to be understood that the present invention may be embodied with various other changes, modifications and improvements (not illustrated herein), which may occur to those skilled in the art, without departing from the spirit of the invention.

### EXAMPLES

To further clarify the present invention, a typical example of the present invention will be described. However, it is to be understood that the invention is not limited to the details of the illustrated example and the foregoing description.

Two copper plates made of oxygen-free copper having a thickness of 0.5 mm, a width of 100 mm and a length of 200 mm were provided. One aluminum plate made of JIS A1060 material having a thickness of 2.5 mm, a width of 100 mm and a length of 200 mm was provided. The copper plates and the aluminum plate were subjected to a degreasing treatment with an organic solvent according to a conventional method, and were dried. Then, the cladding surfaces of the copper plates and aluminum plate were subjected to a hairline finishing treatment to prevent their slippery nature.

The two copper plates were superposed on the respective opposite major surfaces of the aluminum plate so that the cladding surfaces of the copper plates and aluminum plate subjected to the hairline finishing treatment are held in contact with each other. Then, the thus obtained stack of the copper and aluminum plates was heated in a heating furnace and subjected to a clad-rolling operation at a temperature of 300° C. until the thickness of the stack is reduced to 1.9 mm. Thus, a clad plate (plate-like conductor) consisting of the aluminum plate and the copper plates integrally clad on the respective opposite major surfaces of the aluminum plate was obtained. An observation of a cross sectional surface of the clad plate revealed that the central thickness portion of the clad plate in the form of the aluminum layer has a thickness (T₁) of about 1.1 mm, each of the two outer thickness portions of the clad plate in the form of the two copper layers has a thickness (T₃) of about 0.3 mm, and each of the alloy layers consisting of aluminum and copper has a thickness (T₂) of about 0.1 mm.

A test piece having a thickness of 1.9 mm, a width of 100 mm and a length of 100 mm was cut out from the thus obtained clad plate, to evaluate its corrosion resistance (durability). Namely, the test piece was consecutively subjected to 3,000 heating and cooling cycles. In each of the cycles, the test piece was heated to a temperature of 150° C. and then cooled to a temperature of −40° C. Then, a cross section in the areas of boundary between the aluminum layer and the copper layer was observed with a microscope and evaluated for existence of corrosion. The test piece showed no corrosion.

On the other hand, a comparative test piece was provided by plating each of the opposite major surfaces of an aluminum plate made of JIS A1060 material and having a thickness of 1.7 mm, a width of 100 mm and a length of 100 mm, with copper with a thickness of 0.1 mm. Evaluation of the obtained comparative test piece for existence of corrosion in the same manner as described above revealed apparent corrosion in the comparative test piece.

### NOMENCLATURE OF ELEMENTS

2: Aluminum plate

2′: Aluminum layer

4: Copper plates

4′: Copper layers

6: Stack of plates superposed on each other

8: Alloy layers

10: Clad body

1. A plate-like conductor for a busbar, which is a clad member consisting of two copper layers derived from respective two copper plates clad on respective opposite major surfaces of an aluminum plate, an aluminum layer derived from the aluminum plate and formed integrally with the copper layers, and two alloy layers consisting of aluminum and copper and formed between the aluminum layer and the respective two copper layers.

2. The plate-like conductor according to claim 1, wherein each of the two copper layers has a thickness of 0.01-0.8 mm, and the aluminum layer has a thickness of 0.2-2 mm, while each of the two alloy layers has a thickness of 0.01-0.4 mm, the clad member having a total thickness of 0.25-4 mm.

3. The plate-like conductor according to claim 1, wherein the clad member is formed by superposing the two copper plates on the opposite major surfaces of the aluminum plate, to form a stack of the two copper plates and the aluminum plate, and clad-rolling the stack while being heated.

4. The plate-like conductor according to claim 1, wherein the copper plates are made of a copper material or a copper alloy material.

5. The plate-like conductor according to claim 4, wherein the copper material is any one of oxygen-free copper, tough pitch copper and phosphorus-deoxidized copper.

6. The plate-like conductor according to claim 1, wherein the aluminum plate is made of an aluminum material or an aluminum alloy material.

7. The plate-like conductor according to claim 6, wherein the aluminum material is 1000 series aluminum of JIS.

8. The plate-like conductor according to claim 6, wherein the aluminum alloy material is a 6000 series aluminum alloy of JIS.

9. A busbar consisting of a plate-like conductor as defined in claim 1.

10. A method of producing a plate-like conductor for a busbar, comprising the steps of: superposing two copper plates on opposite major surfaces of an aluminum plate to form a stack of the two copper plates and the aluminum plate; and clad-rolling the stack while being heated to form the plate-like conductor for a busbar, which is a clad member consisting of two copper layers derived from respective two copper plates clad on respective opposite major surfaces of an aluminum plate, an aluminum layer derived from the aluminum plate and formed integrally with the copper layers, and two alloy layers consisting of aluminum and copper and formed between the aluminum layer and the respective two copper layers.

11. The method according to claim 10, wherein the stack is heated to 200-450° C.

12. The method according to claim 10, wherein cladding surfaces of at least one of the copper plates and the aluminum plate are subjected to a surface roughening treatment.
